(19) United States
(12) Patent Application Publication
(10) Pub. No.: US 2015/0226324 A1
(43) Pub. Date: Aug. 13, 2015

(54) METHOD FOR OPERATION OF A TRANSMISSION UNIT

(71) Applicant: ZF Friedrichshafen AG, Friedrichshafen (DE)

(72) Inventors: Johannes GLUCKLER, Friedrichshafen (DE); Bernard HUNOLD, Friedrichshafen (DE)

(21) Appl. No.: 14/578,731

(22) Filed: Dec. 22, 2014

(30) Foreign Application Priority Data
Feb. 11, 2014 (DE) 10 2014 202 381.5

(51) Int. Cl. F16H 61/688; F16H 37/04; F16H 61/04

(52) U.S. Cl. CPC F16H 61/688; F16H 61/04; F16H 37/046; F16H 2200/0078

(57) ABSTRACT

A method of operating a transmission unit, in particular a main transmission group of a dual-clutch transmission of multi-group design. The transmission unit has a first input shaft and at least one first shifting element, that is associated with the first input shaft, that can be disengaged and engaged for engaging a gear step, and a second input shaft and at least one second shifting element, that is associated with the second input shaft, that can be disengaged and engaged for engaging a gear step. The at least one first shifting element and/or the at least one second shifting element is/are engaged, without involvement in any drive power flow, in order to minimize rotational speed differences in the transmission unit.

This application claims priority from German patent application serial no. 10 2014 202 381.5 filed Feb. 11 2014.

### FIELD OF THE INVENTION

The invention concerns a method for operating a transmission unit, in particular a main transmission group of a dual-clutch transmission of multi-group design, the transmission unit having a first input shaft, at least one first shifting element that is associated with the first input shaft and that can be opened and closed for engaging a gear ratio step, a second input shaft and at least one second shifting element that is associated with the second input shaft and that can be opened and closed for engaging a gear ratio step.

### BACKGROUND OF THE INVENTION

From the German patent application filed on Sep. 27, 2012 with file number 10 2012 217 503 a transmission is known, in particular a dual-clutch transmission for a motor vehicle, which comprises two partial transmissions each of which has at least one input shaft, and wherein the at least two input shafts on a drive input side of the transmission are arranged on an input shaft axis, an output shaft as the drive output shaft of both partial transmissions is arranged on a drive output side of the transmission, an upstream group having at least one countershaft, and a planetary transmission that can be connected to the drive output shaft, such that at least one of the input shafts can be connected to the drive output shaft by way of at least one gear plane and/or at least one shifting element and by way of the planetary transmission, wherein M gear planes and N shifting elements are arranged, N and M in each case being a natural number larger than or equal to two, wherein the upstream group comprises at least two countershafts, wherein at least two of the countershafts are respectively arranged on different countershaft axes, and wherein the gear steps that can be obtained by means of the M gear planes and the N shifting elements are fully powershiftable, and one of the N shifting elements is provided for actuating the planetary transmission in order to provide a gear for a motor vehicle, which transmission has good powershifting ability and is capable of effective hybridization.

### SUMMARY OF THE INVENTION

The purpose of the present invention is to provide an improved method for operating a transmission unit of the type described to begin with. In particular, a better method for operating a transmission according to the German patent application with file number 10 2012 217 503 filed on Sep. 27, 2012 should be provided. In that connection, for more exact information about the features of the present invention explicit reference should be made to the German patent application with file number 10 2012 217 503 filed on Sep. 27, 2012. The technical features of that patent application are to be regarded as a constituent of the present document. Features of the patent application are features of the present document, in particular inasmuch as they are relevant for the method claimed herein.

The objective of the invention is in particular to operate the transmission unit with higher efficiency. In particular, the transmission unit should be operated with reduced losses. In particular, the transmission unit should be operated with reduced drag torques. In particular, during operation of the transmission unit drag torques, particularly at bearings, seals and/or synchronizers, should be reduced. In particular the transmission unit should be operated in such manner that its life is extended and/or its design is improved.

These objectives are achieved with a method for operating a transmission unit, in particular a main transmission group of a dual-clutch transmission of multi-group design, the transmission unit comprising a first input shaft, associated with the first input shaft at least one shifting element that can be opened and closed in order to engage a gear step, a second input shaft and associated therewith at least one shifting element that can be opened and closed to engage a gear step, wherein the at least one first shifting element and/or the at least one second shifting element is/are closed without involvement in a drive power flow in order to minimize rotational speed differences in the transmission unit.

The transmission unit can be operated in a drive-train of a motor vehicle. The motor vehicle can be a commercial vehicle (CV). The motor vehicle can be a freight-carrying vehicle (FCV). The motor vehicle can be a long-haul truck. The drive-train can comprise an internal combustion engine. The drive-train can comprise a dual clutch. The drive-train can comprise at least one drivable wheel. In the drive-train, the transmission unit can be arranged between the dual clutch and the at least one drivable wheel.

The dual-clutch transmission can comprise a first transmission group and a second transmission group. The dual-clutch transmission can be of coaxial design. The first transmission group can be a main transmission group. The main transmission group can be a step transmission. The main transmission can be a stationary transmission. The main transmission group can be of countershaft design. The second transmission group can be an auxiliary transmission group. The auxiliary transmission group can be a downstream group. The auxiliary transmission group can be a range group. The auxiliary transmission can be a step transmission. The auxiliary transmission group can be an epicyclic gear set. The auxiliary transmission group can be of planetary design.

The transmission unit can comprise a first partial transmission. The first partial transmission can be associated with the first input shaft. The first partial transmission can have first gear steps. The first partial transmission can serve to engage the first gears. The transmission unit can comprise a second partial transmission. The second partial transmission can be associated with the second input shaft. The second partial transmission can have second gear steps. The second partial transmission can serve to engage the second gears.

The dual clutch can comprise a first powershift element and a second powershift element. With the help of the dual clutch the first input shaft and/or the second input shaft can be connected to or separated from the internal combustion engine. When an input shaft is connected to the internal combustion engine, a power flow by way of the corresponding partial transmission is enabled. When an input shaft is separated from the internal combustion engine, the corresponding partial transmission is free from load and gearwheel steps can be shifted in that partial transmission. With the help of the dual clutch, a power flow between the first input shaft and the second input shaft can be produced by means of an overlapping shift, in that one powershift element is closed and at the same time the other powershift element is opened. In this way a shift between gears in different partial transmissions is enabled without, or at least with reduced traction force interruption. The dual-clutch transmission can be fully powershiftable.

The first and second input shafts can be arranged coaxially and concentrically with one another. The first input shaft can be arranged at least in part inside the second input shaft. The second input shaft can be a hollow shaft. The transmission unit can have an output shaft. The transmission unit can have a main axis. The input shafts and the output shaft can be arranged on the main axis. The transmission unit can comprise at least one countershaft. The transmission unit can comprise a first countershaft and a second countershaft. The transmission unit can have at least one countershaft axis. The transmission unit can have a first countershaft axis and a second countershaft axis. The main axis and the at least one countershaft axis can be a distance apart from one another.

A gear step can comprise at least two gearwheels. A gear step can be a gearwheel stage. A gear step can also be called a gearset. The gearwheels of a gear step can form at least one gearwheel pair. The gearwheels of a gear step can be arranged in a gear plane. A gear step can comprise a loose wheel and a fixed wheel. Between an input shaft and the at least one countershaft, gear steps can be arranged. The loose wheels can be arranged on an input shaft. The fixed wheels can be arranged on the at least one countershaft.

The transmission unit can comprise shifting devices. A shifting device can comprise at least one shifting element. A shifting device can comprise a single shifting element. A shifting device with a single shifting element can be described as a simple shifting device. A shifting device can comprise two shifting elements. A shifting device with two shifting elements can be described as a double shifting element. With the help of a shifting element a loose wheel of a gear step can be connected to a shaft carrying the loose wheel, or separated from a shaft carrying the loose wheel. Such connection can also be described as closing of the shifting element, whereas separation can also be called opening of the shifting element. A shifting element can enable a shape-interlocked connection of a loose wheel to a shaft carrying the loose wheel. A shifting element can comprise a claw clutch. A shifting device can comprise a shifting sleeve. A shifting element can comprise a synchronizing device. A synchronizing device can enable a reduction of a rotational speed difference. A shifting device can be opened and closed by means of an actuating device. A shifting device can be opened and closed automatically. A shifting device can be opened and closed by means of an actuator device. The actuator device can comprise at least one electric motor actuator. The actuator device can comprise at least one hydraulic actuator. The actuator device can comprise at least one electro-hydraulic actuator. A shifting device can be opened and closed with the help of a control unit. The control unit can serve to control the actuator device. The transmission unit can comprise a housing. The transmission unit can comprise bearings. The transmission unit can comprise seals.

The transmission unit can comprise a first shifting device. The first shifting device can comprise the at least one first shifting element. The first shifting device can comprise two first shifting elements. The transmission unit can comprise a second shifting device. The second shifting device can comprise the at least one second shifting element. The second shifting device can comprise two second shifting elements.

With the help of the shifting elements a drive power flow can be produced between an input shaft and the output shaft. A shifting element can be closed in order to transmit drive power. A shifting element via which no drive power is flowing can be opened or closed independently of any drive power flow. Opening or closing of a shifting element not involved in a drive power flow can bring about changes of rotational speed differences in the transmission unit. Opening or closing of a shifting element not involved in a drive power flow can minimize rotational speed differences. A shifting element not involved in any drive power flow can be closed in order to minimize rotational speed differences in the transmission unit.

With the help of the transmission unit various gears can be engaged. The gears can be stepped. The gears can form a gear sequence.

The at least one first shifting element can be closed without being involved in a drive power flow in the transmission unit in order to minimize rotational speed differences, and the at least one second shifting element can be closed in order to transmit a drive power.

The transmission unit can comprise an output shaft. The transmission unit can comprise a third shifting device. The third shifting device can comprise the third shifting element. The third shifting element can be opened and closed in order to connect/separate the output shaft to/from the first input shaft. The transmission unit can comprise a fourth shifting device. The fourth shifting device can comprise at least one fourth shifting element. The fourth shifting device can comprise two fourth shifting elements. The at least one fourth shifting element can be associated with the output shaft. The at least one fourth shifting element can be opened and closed in order to engage a gear step.

To obtain a first gear ratio of the transmission unit, a first shifting element can be closed in the transmission unit without being involved in a drive power flow, in order to minimize rotational speed differences, a second shifting element can be closed in order to transmit drive power, the third shifting element can be open and a fourth shifting element can be closed in order to transmit drive power.

The at least one first shifting element can be closed in order to transmit a drive power and the at least one second shifting element can be closed without involvement in any drive power flow in order to minimize rotational speed differences in the transmission unit.

To obtain a second gear ratio of the transmission unit, a first shifting element can be closed in order to transmit drive power, a second shifting element can be closed without involvement in any drive power flow in order to minimize rotational speed differences in the transmission unit, the third shifting element can be opened and a fourth shifting element can be closed in order to transmit drive power.

The third shifting element can be closed to transmit drive power and the at least one first shifting element and the at least one second shifting element can be closed, without involvement in any drive power flow, in order to minimize rotational speed differences in the transmission unit.

To obtain a third gear ratio of the transmission unit, a first and a second shifting element can be closed without involvement in any drive power flow in order to minimize rotational speed differences in the transmission unit, the third shifting element can be closed in order to transmit drive power, and the at least one fourth shifting element can be opened.

The first input shaft of the transmission unit can be connected to a first powershift element of a dual clutch and the second input shaft of the transmission unit can be connected to a second powershift element of the dual clutch.

To carry out a powershift, the first powershift element can be shifted actively from a closed idle position to an open operating position or passively from the open operating position to the closed idle position and the second powershift element can be shifted actively from an open operating position to a closed idle position or passively from the closed idle position to the open operating position. The first powershift element can be a normally-closed clutch. The second powershift element can be a normally-open clutch.

To carry out a powershift, the first powershift element and the second powershift element can in each case be shifted actively from an open operating position to a closed idle position, or passively from the closed idle position to the open operating position. The first powershift element and the second powershift element can be normally-open clutches.

To carry out a powershift, the first powershift element can be shifted actively from an open operating position to a closed idle position or passively from the closed idle position to the open operating position, and the second powershift element can be shifted actively from a closed idle position to an open operating position or passively from the open operating position to the closed idle position. The first powershift element can be a normally-open clutch and the second powershift element can be a normally-closed clutch.

To obtain a fourth gear ratio of the transmission unit, the at least one first shifting element can be opened, a second shifting element closed without involvement in any drive power flow in the transmission unit in order to minimize rotational speed differences, the third shifting element closed in order to transmit drive power and the at least one fourth shifting element opened.

To carry out a powershift, the first powershift element and the second powershift element can in each case be actively shifted from a closed idle position to an open operating position or passively from the open operating position to the closed idle position. The first and second powershift elements can both be normally-closed clutches.

The transmission unit can comprise at least one countershaft and the at least one first shifting element and the at least one second shifting element can be opened in order to decouple the at least one countershaft. In this way, once the shifting elements have been opened the at least one countershaft can run down to rotational speed n=0.

The transmission unit can be connected to an additional transmission group, which additional transmission group can comprise a first additional shifting element that can be opened and closed in order to engage a gear step, and a second additional shifting element that can be opened and closed in order to engage a gear step. In order to obtain a first gear sequence, the first additional shifting element can be opened and the second additional shifting element can be closed, whereas to obtain a second gear sequence, the first additional shifting element can be closed and the second additional shifting element can be opened.

The method according to the invention makes it possible to reduce rotational speed differences in the transmission unit. The transmission unit can be operated with greater efficiency. The transmission unit can be operated with reduced losses. The transmission unit can be operated with reduced drag torques. During operation of the transmission unit drag torques, for example at bearings, seals and/or synchronizers, are reduced. The transmission unit can be operated in such manner that its life is extended and/or it can be designed in a better way.

### BRIEF DESCRIPTION OF THE DRAWINGS

Below, example embodiments of the method according to the invention are described in more detail, with reference to the figures. From the description, further features and advantages emerge.

The figures show, schematically and as examples:

FIG. 1: A powershiftable dual-clutch transmission of two-group design, with a main group of countershaft structure and an additional transmission of planetary design,

FIG. 2: A shifting matrix for a dual-clutch transmission with two powershift elements and nine shifting elements for powershifting twelve gears forforward drive, and

FIG. 3: A shifting matrix for a dual-clutch transmission with two powershift elements and eleven shifting elements for powershifting seventeen gears forforward drive and one gear for reverse drive.

### DETAILED DESCRIPTION OF THE PREFERRED EMBODIMENTS

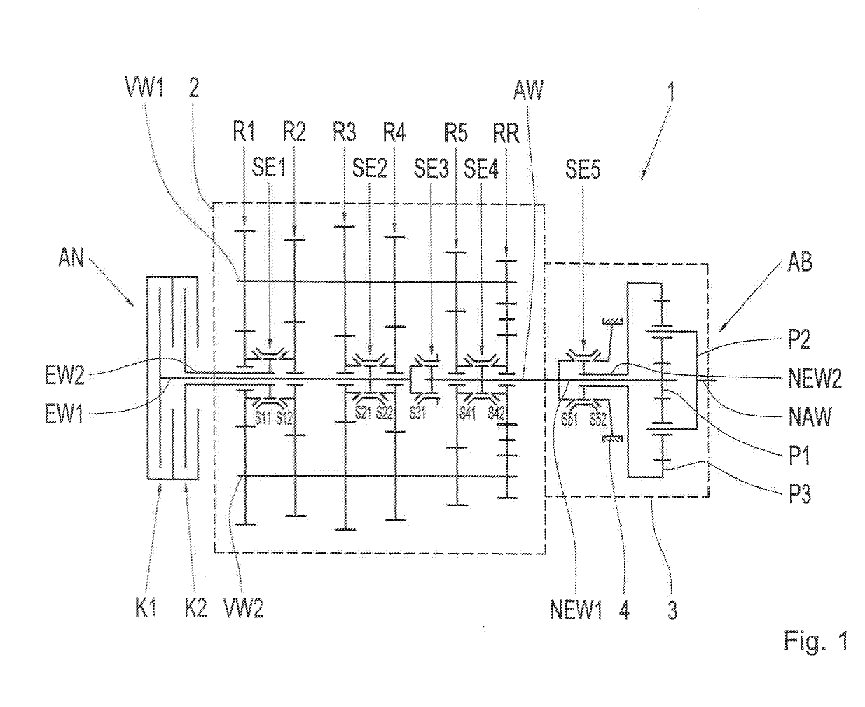

FIG. 1 shows a powershiftable dual-clutch transmission 1 of two-group design, with a main group 2 of countershaft structure and an additional transmission group 3 of planetary design.

The main group 2 has five gear steps R1, R2, R3, R4, R5 for forward drive and one gear step RR for reverse drive. The additional transmission group 3 has two shiftable gears and serves as a downstream range group.

The dual-clutch transmission 1 has a drive input side AN and a drive output side AB. The main group 2 is arranged on the drive input side AN of the dual-clutch transmission 1. The main group 2 has a first input shaft EW1 and a second input shaft EW2. The first input shaft EW1 can be engaged in a power flow with the help of a first powershift element K1. The second input shaft EW2 can be engaged in a power flow with the help of a second powershift element K2. By alternating actuation of the powershift elements K1, K2 a power flow can be engaged by successive changes between the first input shaft EW1 and the second input shaft EW2. The first input shaft EW1 and the second input shaft EW2 are arranged coaxially and concentrically on a main axis of the main group 2. The first input shaft EW1 is arranged partially inside the second input shaft EW2. The second input shaft EW2 is in the form of a hollow shaft.

The main group 2 has an output shaft AW. In the present case the main group 2 has a first countershaft VW1 and a second countershaft VW2. Alternatively, the main group 2 can also have only one countershaft. The input shafts EW1, EW2 and the output shaft AW are arranged coaxially with one another on the main axis of the main group 2. The countershafts VW1, VW2 are each arranged parallel to the main axis and at a distance away from it.

The gear steps R1, R2 serve, respectively, to direct power flow between the second input shaft EW2 and the countershafts VW1, VW2. The gear steps R1, R2 can together be disengaged from a power flow or, as desired, respectively engaged in a power flow. The gear steps R3, R4 serve, respectively, to direct power flow between the first input shaft EW1 and the countershafts VW1, VW2. The gear steps R3, R4 can together be disengaged from a power flow or, as desired, respectively engaged in a power flow. The gear steps R5, RR serve respectively to direct a power flow between the countershafts VW1, VW2 and the output shaft AW. With the help of the gear step RR the rotational direction of the output shaft AW can be reversed. The gear steps R5, RR can together be disengaged from a power flow or, as desired, respectively engaged in a power flow.

The gear steps R1, R2 each have a loose wheel associated with the second input shaft EW2 and fixed wheels arranged on the countershafts VW1, VW2. The gear steps R3, R4 each have a loose wheel associated with the first input shaft EW1 and fixed wheels arranged on the countershafts VW1, VW2. The gear steps R5, RR each have a loose wheel associated with the output shaft AW and fixed wheels arranged on the countershafts VW1, VW2.

The main transmission 2 has shifting devices SE1, SE2, SE3, SE4. The shifting device SE1 is arranged on the second input shaft EW2. The shifting device SE2 is arranged on the first input shaft EW1. In the present case, the shifting device SE3 is arranged on the output shaft AW. Alternatively, the shifting device SE3 can also be arranged on the first input shaft FW1. The shifting device SE4 is arranged on the output shaft AW. The shifting device SE1 is a double shifting device. The shifting device SE1 has shifting elements S11, S12. The shifting device SE2 is a double shifting device with shifting elements S21, S22. The shifting device SE3 is a single sifting device, with a shifting element S31. The shifting device SE4 is a double shifting device. The shifting device SE4 has shifting elements S41 S42.

The shifting element S11 serves to engage the gear step R1. The shifting element S12 serves to engage the gear step R2. The shifting element S21 serves to engage the gear step R3. The shifting element S22 serves to engage the gear step R4. The shifting element S31 serves to connect/separate the first input shaft EW1 to/from the output shaft AW. The shifting element S41 serves to engage the gear step R5. The shifting element S42 serves to engage the gear step RR.

The additional transmission group 3 is arranged on the drive output side AB of the dual-clutch transmission 1 The additional transmission group serves to extend a gear step sequence of the main group 2. The additional transmission group 3 has a first input shaft NEW1, a second input shaft NEW2 and an output shaft NAW. The first and second input shafts NEW1, NEW2 are arranged coaxially and concentrically with one another. The first input shaft NEW1 is arranged partially inside the second input shaft NEW2. The second input shaft NEW2 is in the form of a hollow shaft. The additional transmission group 3 comprises a sun gear P1, planetary gearwheels, a carrier P2, a ring gear P3 and a housing 4. The first input shaft NEW1 is connected fixed to the sun gear P1. The second input shaft NEW2 is connected fixed to the ring gear P3. The output shaft NAW is connected fixed to the carrier P2. The output shaft AW of the main group 2 and the first input shaft NEW1 of the additional transmission group 3 are formed with a common input/output shaft.

The additional transmission group 3 has a shifting device SE5. The shifting device SE5 is a double shifting device with shifting elements S51, S52. The shifting element S51 serves to connect/separate the input/output shaft AW, NEW1 to/from the second input shaft NEW2. The shifting element S52 serves to connect/separate the second input shaft NEW2 to/from the housing 4.

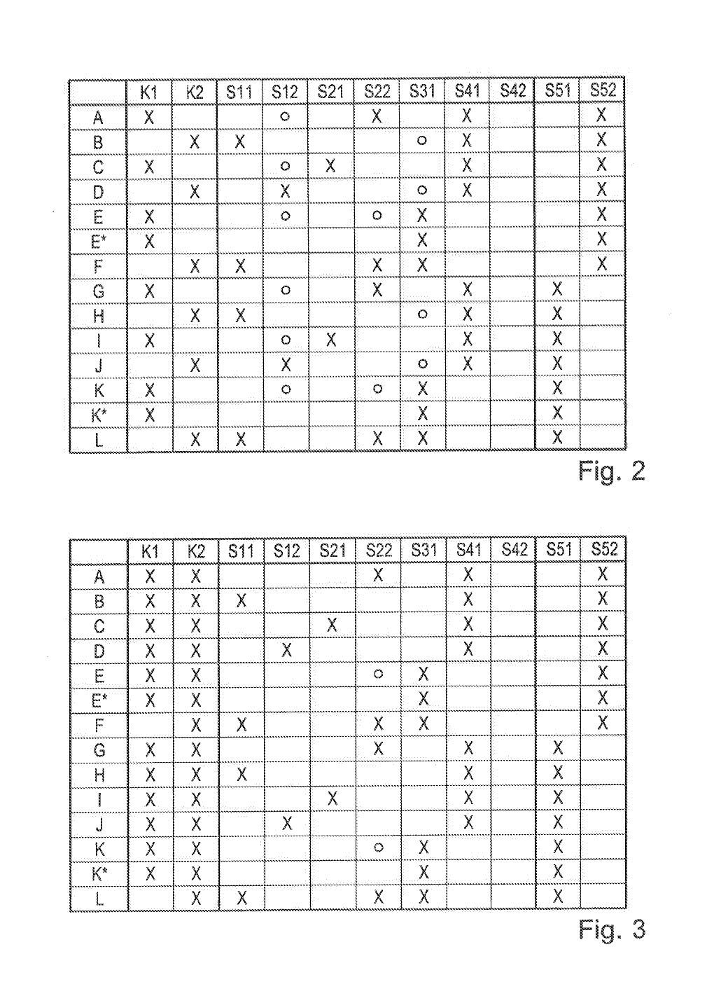

FIG. 2 shows a shifting matrix for a dual-clutch transmission with two powershift elements K1, K2 and nine shifting elements S11, S12, S21, S22, S31, S41, S42, S51, S52 for powershifting twelve gears A, B, C, D, E, E*, F, G, H, J, K*, L for forward driving, like the dual-clutch transmission 1 according to FIG. 1.

In the shifting matrix, the rows represent the gears A, B, C, D, E, E*, F, G, H, I, J, K, K*, L and columns represent the shifting elements S11, S12, S21, S22, S31, S41, S42, S51, S52. In addition, in the shifting matrix columns are shown for the powershift elements K1, K2, In the shifting matrix “X” and “◯”, respectively, denote closed shift conditions of the shifting elements or powershift elements. In the shifting matrix “X” denotes a closed shift condition of shifting elements via which drive power is transmitted. In the shifting matrix “◯” denotes a closed shift condition of shifting elements, in which the shifting element concerned is not involved in drive power flow and is only closed in order to minimize rotational speed differences in the transmission unit.

In gear ratio A, the powershift element K1 and the shifting elements S12, S2, S41, S52 are closed, whereas the other shifting elements are open. In gear ratio B, the powershift element K2 and the shifting elements S11, S31, S41, S52 are closed and the other shifting elements are open. In gear ratio C, the powershift element K1 and the shifting elements S12, S21, S41, S52 are closed, while the other shifting elements are open. In gear ratio D, the powershift element K2 and the shifting elements S12, S31, S41, S52 are closed and the other shifting elements are open. In gear ratio E, the powershift element K1 and the shifting elements S12, S22, S31, S52 are closed while the other shifting elements are open. In gear ratio E*, the powershift element K1 and the shifting elements S31, S52 are closed while the other shifting elements are open. Thus, the countershafts are decoupled. In gear ratio F, the powershift element K2 and the shifting elements S11, S22, S31, S52 are closed and the other shifting elements are open. In gear ratio G, the powershift element K1 and the shifting elements S12, S22, S41, S51 are closed and the other shifting elements are open. In gear ratio H, the powershift element K2 and the shifting elements S11, S31, S41. 351 are closed and the other shifting elements are open. In gear ratio I, the powershift element K1 and the shifting elements S12, S21, S41, S51 are closed and the other shifting elements are open. In gear ratio J, the powershift element K2 and the shifting elements S12, S31, S41, S51 are closed and the other shifting elements are open. In gear ratio K, the powershift element K1 and the shifting elements S12, S22, S31, 551 are closed and the other shifting elements are open. In gear ratio K*, the powershift element K1 and the shifting elements S31, S51 are closed and the other shifting elements are open. Thus, the countershafts are decoupled. In gear ratio L, the powershift element K2 and the shifting elements S11, S22, S31, S51 are closed and the other shifting elements are open.

A shift between gears ratios A, C, E, E*, G, I, K, K*, L, which can be engaged in a power flow with the help of the powershift element K1, on the one hand, and the gears ratio B, D, F, H, J, L, which can be engaged in a power flow with the help of the powershift element K2, on the other hand, can take place with powershifting. The powershift element K1 can have a preferred closed condition (normally closed) and the powershift element K2 can have a preferred open condition (normally open). The powershift element K1 can be normally open and the powershift element K2 can be normally open. The powershift element K1 can be normally open and the powershift element K2 can be normally closed.

FIG. 3 shows a shifting matrix for a dual-clutch transmission with two powershift elements K1, K2 and nine shifting elements S11, S12, S21, S22, S31, S41 S42, 351, S52 for the powershifting of twelve gears ratios A, B, C, D, E, E*, F, G, H, I, J, K, K*, L for forward driving, like the dual-clutch transmission 1 according to FIG. 1.

In the shifting matrix, the rows represent the gears ratios A, B, C, D, E, E*, F, G, H, I, J, K, K*, L and columns represent the shifting elements S11, S12, S21, S22, S31, S41, S42, S51, S52. In addition, in the shifting matrix columns are provided for the powershift elements K1, K2. In the shifting matrix, “X” and “◯”, respectively, denote closed shift conditions of the shifting elements or powershift elements. In the shifting matrix, “X” denotes a closed shift condition of shifting elements via which drive power is transmitted. In the shifting matrix, “◯” denotes a closed shift condition of shifting elements, in which the shifting element concerned is not involved in a drive power flow and is only closed in order to minimize rotational speed differences in the transmission unit.

In gear ratio A, the powershift elements K1, K2 and the shifting elements S22, S41, S52 are closed, while the other shifting elements are open. The drive power flows by way of the powershift element K1, whereas the powershift element K2 only governs the rotational speed. In gear ratio B, the powershift elements K1, K2 and the shifting elements S11 S41, S52 are closed while the other shifting elements are open. The drive power flows by way of the powershift element K2, whereas the powershift element K1 only governs the rotational speed. In gear ratio C, the powershift elements K1, K2 and the shifting elements S21, S41, S52 are closed while the other shifting elements are open. Drive power flows by way of the powershift element K1, while the powershift element K2 only governs the rotational speed. In gear ratio D, the powershift elements K1, K2 and the shifting elements S12, S41, S52 are closed whereas the other shifting elements are open. Drive power flows by way of the powershift element K2, while the powershift element K1 only governs the rotational speed. In gear ratio E, the powershift elements K1, K2 and the shifting elements S22, S31, S52 are closed and the other shifting elements are open. Drive power flows by way of the powershift element K1 while the powershift element K2 only governs the rotational speed. In gear ratio E*, the powershift elements K1, K2 and the shifting elements S31, S52 are closed and the other shifting elements are open. Drive power flows by way of the powershift element K1, whereas the powershift element K2 only governs the rotational speed. Thus, the countershafts are decoupled. In gear ratio F, the powershift element K2 and the shifting elements S11, S22, S31, S52 are closed, while the other shifting elements are open. In gear ratio G, the powershift elements K1, K2 and the shifting elements S22, S41, S51 are closed whereas the other shifting elements are open. Drive power flows by way of the powershift element K1, while the powershift element K2 only governs the rotational speed. In gear ratio H, the powershift elements K1, K2 and the shifting elements S11 S41, S51 are closed and the other shifting elements are open. Drive power flows by way of the powershift element K2, while the powershift element K1 only governs the rotational speed. In gear ratio I, the powershift elements K1, K2 and the shifting elements S21, S41, S51 are closed while the other shifting elements are open. Drive power flows by way of the powershift element K1, whereas the powershift element K2 only governs the rotational speed. In gear ratio J, the powershift elements K1, K2 and the shifting elements S12, S41, S51 are closed and the other shifting elements are open. Drive power flows by way of the powershift element K2, while the powershift element K1 only governs the rotational speed. In gear ratio K, the powershift elements K1, K2 and the shifting elements S22, S31, S51 are closed and the other shifting elements are open. Drive power flows by way of the powershift element K1 while the powershift element K2 only governs the rotational speed. In gear ratio K*, the powershift elements K1, K2 and the shifting elements S31, S51 are closed while the other shifting elements are open. Drive power flows by way of the powershift element K1, while the powershift element K2 only governs the rotational speed. Thus, the countershafts are decoupled. In gear ratio L, the powershift element K2 and the shifting elements S11, S22, S31, S51 are closed, while the other shifting elements are open.

A shift between the gears ratios A, C, E, E*, G, I, K, K*, Ion the one hand and the gears ratios B, D, F, H, J, L on the other hand can be carried out with powershift. The powershift elements K1, K2 can each have a preferred open position (normally open). The powershift elements K1, K2 can each have a preferred closed position (normally closed).

### Indexes

1 Dual-clutch transmission
2 Main transmission
3 Additional transmission group
4 Housing
AN Drive input side
AB Drive output side
EW1 First input shaft
EW2 Second input shaft
VW1 First countershaft
VW2 Second countershaft
AW Output shaft
#
NEW1 First input shaft
NEW2 Second input shaft
NAW Output shaft
SE1 Shifting device
SE2 Shifting device
SE3 Shifting device
SE4 Shifting device
SE5 Shifting device
S11 Shifting element
S12 Shifting element
S21 Shifting element
S22 Shifting element
S31 Shifting element

S41 Shifting element
S42 Shifting element
S51 Shifting element
S52 Shifting element
R1 Gear step
R2 Gear step
R3 Gear step
R4 Gear step
R5 Gear step
R6 Gear step
P1 Sun gear
P2 Carrier
P3 Ring gear
K1 First powershift element
K2 Second powershift element
A Gear ratio
B Gear ratio
C Gear ratio
D Gear ratio
E Gear ratio
E* Gear ratio
F Gear ratio
G Gear ratio
H Gear ratio
I Gear ratio
J Gear ratio
K Gear ratio
K* Gear ratio
L Gear ratio

1-15. (canceled)

16. A method of operating a transmission unit (2) of a dual-clutch transmission (1) of a multi-group design, the transmission unit comprising a first input shaft (EW1), and at least one first shifting element (S11, S12) being associated with the first input shaft (EW1) and being engagable and disengageable for engaging a gear step, a second input shaft (EW2), and at least one second shifting element (S21, S22) being associated with the second input shaft (EW2) and being engagable and disengageable for engaging a gear step, the method comprising the steps of:
engaging at least one of, the at least one first shifting element (S11, S12) and the at least one second shifting element (S21, S22), without involvement in any drive power flow, to minimize rotation speed differences in the transmission unit.

17. The method according to claim 16, further comprising the steps of:
engaging the at least one first shifting element (S12), without involvement in any drive power flow in the transmission unit, to minimize the rotation speed differences; and
engaging the at least one second shifting element (S21, S22) to transmit a drive power.

18. The method according to claim 17, further comprising the steps of providing the transmission unit with an output shaft (AW), a third shifting element (S31) that is disengageable and engagable to either connect or separate the output shaft (AW) and the first input shaft (EW1), and at least one fourth shifting element (S41, S42) that is associated with the output shaft (AW) and that is disengageable and engagable for engaging a gear step, and
obtaining first gear ratios (A, C, G, I) of the transmission unit by engaging a first shifting element (S12), without involvement in drive power flow in the transmission unit, to minimize rotation speed differences, engaging a second shifting element (S21, S22) to transmit drive power, disengaging the third shifting element (S31), and engaging a fourth shifting element (S41) in order to transmit a drive power.

19. The method according to claim 16, further comprising the step of transmitting drive power by engaging the at least one first shifting element (S11, S12) and disengaging the at least one second shifting element (S22).

20. The method according to claim 19, further comprising the steps of providing the transmission unit with an output shaft (AW), a third shifting element (S31) that is disengageable and engageable to either connect or separate the output shaft (AW) and the first input shaft (EW1), and at least one fourth shifting element (S41, S42) that is associated with the output shaft (AW) and that is disengageable and engageable to engage a gear step ratio, and
obtaining second gear ratios (B, D, H, J) of the transmission unit by engaging a first shifting element (S11, S12) to transmit a drive power, disengaging a second shifting element (S22), engaging the third shifting element (S31), without involvement in any drive power flow, to minimize rotational speed differences, and engaging a fourth shifting element (S41) to transmit a drive power.

21. The method according to claim 16, further comprising the steps of providing the transmission unit with an output shaft (AW) and a third shifting element (S31) to connect and separate the output shaft (AW) the first input shaft (EW1), and the third shifting element (S31) for transmitting drive power, and
engaging the at least one first shifting element (S12) and also the at least one second shifting element (S22), without involvement in any drive power flow, to minimize rotational speed differences in the transmission unit.

22. The method according to claim 21, further comprising the steps of providing the transmission unit with at least one fourth shifting element (S41, S42) associated with the output shaft, that is disengageable and engageable to engage a gear step, and
obtaining a third gear ratio (E, K) of the transmission unit by engaging a first shifting element (S12) and a second shifting element (S22), without involvement in any drive power flow in the transmission unit, to minimize rotational speed differences, engaging the third shifting element (S31) to transmit a drive power, and disengaging at least one fourth shifting element (S41, S42).

23. The method according to claim 16, further comprising the steps of connecting the first input shaft (EW1) of the transmission unit to a first powershift element (K1) of a dual clutch and connecting the second input shaft (EW2) of the transmission unit to a second powershift element (K2) of the dual clutch, and
carrying out a powershift by changing the first powershift element (K1) either actively from a closed idle position to an open working position or passively from the open working position to the closed idle position, and changing the second powershift element (K2) either actively from an open working position to a closed idle position or passively from the closed idle position to the open working position.

24. The method according to claim 16, further comprising the steps of connecting the first input shaft (EW1) of the transmission unit to a first powershift element (K1) of a dual clutch and connecting the second input shaft (EW2) of the transmission unit to a second powershift element (K2) of the dual clutch, and carrying out a powershift by changing each of the first powershift element (K1) and the second powershift element (K2) either actively from an open working position to a closed idle position or passively from the closed idle position to the open working position.

25. The method according to claim 16, further comprising the steps of connecting the first input shaft (EW1) of the transmission unit to a first powershift element (K1) of a dual clutch and connecting the second input shaft (EW2) of the transmission unit to a second powershift element (K2) of the dual clutch, and
carrying out a powershift by changing the first powershift element (K1) either actively from an open working position to a closed idle position or passively from the closed idle position to the open working position and changing the second powershift element (K2) either actively from a closed idle position to an open working position or passively from the open working position to the closed idle position.

26. The method according to claim 16, further comprising the steps of providing the transmission unit with an output shaft (AW), a third shifting element (S31) that can be disengaged and engaged to either connect or separate the output shaft (AW) and the first input shaft (EW1), and at least one fourth shifting element (S41, S42) that is associated with the output shaft (AW) and that can be disengaged and engaged to engage a gear step, and
obtaining a fourth gear ratio (E, K) of the transmission unit by disengaging the at least one first shifting element (S11, S12), engaging a second shifting element (S22), without involvement in any drive power flow in the transmission unit, to minimize rotational speed differences, engaging the third shifting element (S31) to transmit a drive power and disengaging the at least one fourth shifting element (S41, S42).

27. The method according to claim 26, further comprising the steps of connecting the first input shaft (EW1) of the transmission unit to a first powershift element (K1) of a dual clutch and connecting the second input shaft (EW2) of the transmission unit to a second powershift element (K2) of the dual clutch, and carrying out a powershift by changing each of the first powershift element (K1) and the second powershift element (K2) either actively from an open working position to a closed idle position or passively from the closed idle position to the open working position.

28. The method according to claim 26, further comprising the steps of connecting the first input shaft (EW1) of the transmission unit to a first powershift element (K1) of a dual clutch and connecting the second input shaft (EW2) of the transmission unit to a second powershift element (K2) of the dual clutch, and carrying out a powershift by changing each of the first powershift element (K1) and the second powershift element (K2) either actively from a closed idle position to an open working position or passively from the open working position to the closed idle position.

29. The method according to claim 16, further comprising the step of providing the transmission unit with at least one countershaft (VW1, VW2), and opening the at least one first shifting element (S11, S12) and the at least one second shifting element (S21, S22) to decouple the at least one countershaft (VW1, VW2).

30. The method according to claim 16, further comprising the steps of connecting the transmission unit to an additional transmission group (3), the additional transmission group (3) comprising a first additional shifting element (S51) that can be disengaged and engaged to engage a gear step, and a second additional shifting element (S52) that can be disengaged and engaged to engage a gear step,
obtaining a first gear sequence (A, B, C, D, E, E*, F) by disengaging the first additional shifting element (S51) and engaging the second additional shifting element (S52), and
obtaining a second gear sequence (G, H, I, J, K, K*) by engaging the first additional shifting element (S51) and disengaging the second additional shifting element (S52).

31. A method of operating a main transmission group of a dual-clutch transmission of multi-group design, the main transmission group comprising first and second input shafts, a first shift element being engagable to couple a first gear step to the first input shaft, a second shift element being engagable to couple a second gear step to the first input shaft, a third shift element being engagable to couple a third gear step to the second input shaft, and a fourth shift element being engagable to couple a fourth gear step to the second input shaft, the method comprising the step of:
engaging at least one of the first, the second, the third and the fourth shifting elements, without involvement in any drive power flow, so as to minimize rotational speed differences in the main transmission group.
